(19) United States
(12) Patent Application Publication
(10) Pub. No.: US 2026/0268109 A1
(43) Pub. Date: Sep. 10, 2026

(54) Smart Card Provided with a Screen for Displaying a Dynamic Code and Method for Manufacturing Same

(71) Applicant: SMART PACKAGING SOLUTIONS, Rousset (FR)

(72) Inventors: Damien Aubert, Rousset (FR); Maxime Di Bernardo, Rousset (FR); Sébastien Marmugi, Rousset (FR)

(21) Appl. No.: 19/153,454

(22) PCT Filed: Feb. 5, 2024
(86) PCT No.: PCT/FR2024/000014

§ 371 Date: Aug. 4, 2025

(30) Foreign Application Priority Data
Feb. 6, 2023 (FR) 2301093

(51) Int. Cl. G06K 19/077

(52) U.S. Cl. CPC G06K 19/07707; G06K 19/07722; G06K 19/07747

(57) ABSTRACT

The invention relates to a smart card (1) comprising a card body (2) made up of a stack of layers rigidly connected to each other and an electronic module (3) integrated into a cavity (4) formed on the upper face of the card body (2), the electronic module (3) comprising a display screen (5) on the lower face thereof, characterised in that the display screen (5) is positioned at the bottom of the cavity (4) in a transparent layer (15) of the card body (2) so as to be visible from the lower face of the smart card, and in that the card body (2) comprises a generally opaque layer (10) arranged under the transparent layer (15) and provided with a non-opaque reserve zone (7) formed opposite the display screen (5).

(57) Abrégé: L'invention concerne une carte à puce (1) comportant un corps de carte (2) formé par un empilement de couches solidaires entre elles et un module électronique (3) intégré dans une cavité (4) aménagée sur la face supérieure du corps de carte (2), ledit module électronique (3) comportant un écran d'affichage (5) sur sa face inférieure, caractérisée en ce que ledit écran d'affichage (5) est positionné au fond de ladite cavité (4) dans une couche transparente (15) du corps de carte (2) de façon à être visible depuis la face inférieure de la carte à puce, et en ce que ledit corps de carte (2) comporte une couche généralement opaque (10) disposée sous ladite couche transparente (15) et pourvue d'une zone de réserve non opaque (7) aménagée en regard de l'écran d'affichage (5).

The present invention relates to a contact or double contact and contactless communication interface smart card provided with a screen for displaying a dynamic security cryptogram called a “dCVV”, an acronym for “dynamic card verification value”. This smart card will, then, be called a “dynamic CVV card”, or more simply a “dCVV card”, below. The invention also relates to the method for manufacturing such a dCVV card.

### PRIOR ART

A dCVV card is intended to make e-commerce transactions more secure and to improve users' online purchase experience, with respect to older cards provided simply with a fixed verification code known as a card verification value, also labeled a CVV, which is a fixed code printed on the card body.

Known dCVV cards have a 3-digit display integrated into the back of standard credit cards. Instead of the 3-digit conventional static CVV code printed on the smart card which can be easily reproduced, this easy-to-use dynamic code solution will prevent fraud referred to as “card-not-present” (CNP) fraud and is likely to give more confidence to consumers, to merchants and to banks in their online transactions. By way of example, the dynamic CVV card referred to as the “eSecu” dynamic CVV card is a conventional EMV contactless payment card which displays a dynamic value which refreshes automatically depending on a one-time password (OTP) which varies depending on time.

These known dCVV cards require the integration into the card body of a specific electronic module, for example such as that described in the document WO 2021/206780 A1 (Linxens) having both a terminal block of contacts which is in accordance with the ISO 7816 standard on the front side, and a screen on the back side for displaying the dCVV code. This type of module, referred to as an “all-in-one” module, has the advantage of integrating all the electronic components which are necessary for the operation of the smart card, in particular the microelectronic chip and its software application, notably of banking type, as well as the screen for displaying the dCVV code.

In principle, this architecture is therefore simple and makes it possible to integrate such a module with all of the necessary electronic components in a cavity of the card body, without requiring the integration of discrete electronic components distributed over a printed circuit integrated into the card body.

However, this known architecture poses new technical problems in practice. A first problem which arises is to obtain a solution which makes it possible to integrate and adhesively bond the electronic module in the machined cavity of the card body while keeping the bottom of the cavity transparent enough to make it possible for the screen to be able to be read properly after it is integrated into the cavity of the card body. The screen located on the back of the electronic module must, in fact, be properly visible at the back of the smart card, while remaining protected from external attacks.

Another problem lies in the fact that dCVV modules can come from various manufacturers and have different dimensions, notably a variable thickness. In order to propose the lowest manufacturing costs to the manufacturers of smart cards which are dedicated to integrating these modules into their card bodies, it is therefore necessary for the structure of the card body and the manufacturing process to make it possible to easily compensate for the differences in thickness of the dCVV modules, along the Z axis corresponding to the thickness of the smart card.

Furthermore, the structure of the smart card must be compatible with the standard card manufacturing methods of manufacturers, in particular with the phases of hot rolling the layers of the card body.

A smart card provided with a screen encapsulated in a layer of transparent material and which remains visible through a transparent window of the card body located facing the screen is known from the document US 2016/260005 A1 (Karafotis et al).

The document US 2014/016286 A1 (Fische et al) describes an electronic module provided with a display screen and with other discrete components, said module being intended to be incorporated into a smart card. The various discrete components and the screen have the same thickness, and the cavity of the card body receiving the module is of uniform thickness.

The document US 2014/0162286 A1 (Tatsu Jintaro) describes a smart card provided with a display screen, with an integrated battery and with an electric switch. The screen is not integrated into an electronic module inserted into a cavity, but is directly integrated into a layer of the card body, facing a transparent window.

### Aim of the Invention

The invention has the general aim of proposing a new smart card structure provided with a module the back side of which has a screen for displaying a dynamic CVV, and its manufacturing method, which is able to solve all of the technical problems cited above.

The invention also has the particular aim of proposing a smart card structure which makes it possible to transfer the electronic module into the cavity of the card body while keeping the bottom of the cavity properly transparent in order to ensure that the screen located on the back side of the electronic module can be read through the bottom of the cavity of the card body, and while protecting the screen from external attacks.

### Subject of the Invention

In principle, the invention makes provision for using, on the back side of the card body (namely, the side opposite that which bears the terminal block of contacts in the format standardized according to the ISO 7816 standard), a layer of transparent plastic material, notably made of PVC, coated with a layer which is opaque to visible light, for example a white layer printed by screen printing or offset printing on the whole surface of the transparent layer made of PVC, with the exception of one non-printed zone located in the position provided for the screen of the electronic module.

Several solutions can be envisaged for producing and fastening the electronic module provided with its screen in the cavity of the card body, located opposite the non-printed zone of a white opaque layer.

According to one embodiment, a hot-melt transparent adhesive is used and it is arranged over the whole lower surface of the module or only along its periphery.

According to another embodiment, use is made of an optical adhesive or resin or a gel which makes it possible to adhesively bond the module and to wet the bottom of the machined cavity of the card body in order to improve the visibility of the screen through the bottom of the cavity. For this purpose, the optical adhesive is chosen to be able to optimize the optical index of the bottom of the cavity.

According to another embodiment, microcapsules filled with a pressure-sensitive bicomponent adhesive, also labeled a “PSA” or a temperature-sensitive bicomponent adhesive are used to fasten the module.

The invention also makes provision for the structure of the card to consist only of layers of different materials which are compatible with hot rolling (notably PVC, PET, PC, etc.), and the structure of the card body must not comprise any electronic component or battery, apart from the antenna of the card.

One subject of the invention is consequently a smart card comprising a card body formed by a stack of layers which are rigidly connected to one another and an electronic module provided, on its upper side, with a terminal block of metal contacts which are likely to interact with the corresponding contacts of a smart card reader and comprising, on its lower side, a display screen, said electronic module being integrated into a cavity formed on the upper side of the card body, and said display screen being positioned at the bottom of said cavity in a transparent layer of the card body so as to be visible from the lower side of the smart card, and said card body comprising a generally opaque layer arranged under said transparent layer and provided with a non-opaque reserve zone formed opposite the display screen, characterized in that the bottom of said cavity has multiple machining depths, which are adapted to the thickness of the display screen and to the thickness of other electronic components arranged on the lower side of the electronic module.

According to one embodiment, said generally opaque layer is produced by white opaque printing on a layer of the card body, and the non-opaque reserve one is produced by an absence of white opaque printing opposite the zone provided for the display screen.

According to one embodiment, the layers of the card body comprise, in order from the upper side of the smart card:
A transparent upper protective layer
A first printed layer provided with a graphical personalization
An opaque layer, notably made of white PVC
An insert provided with an antenna
A transparent layer in which the bottom of said cavity, coated with said white opaque printing with the exception of said reserve zone, extends
A second printed layer provided with a graphical personalization
A transparent lower protective layer.

According to one embodiment, the bottom of said cavity has multiple machining depths, which are adapted to the thickness of the display screen and to the thickness of other electronic components arranged on the lower side of the electronic module.

According to one embodiment, the electronic module is fastened in the cavity of the card body by means of a transparent hot-melt adhesive film arranged on the lower side of the electronic module on and around the display screen and the other components thereof arranged in relief on the lower side of the electronic module.

According to another embodiment, the electronic module is fastened in the cavity of the card body by means of an opaque hot-melt adhesive film which is rolled on the periphery of the lower side of the electronic module around the display screen and the other components thereof.

According to another embodiment, the electronic module is fastened in the cavity of the card body by means of a transparent adhesive dispensed at the bottom of the cavity so as to surround and cover the display screen.

According to another embodiment, the electronic module is fastened in the cavity of the card body by means of the combination of a hot-melt adhesive film which is rolled around the periphery of the electronic module, and a transparent adhesive dispensed at the bottom of the cavity in the zone intended to be opposite the display screen. In this case, the invention makes provision for the transparent adhesive to be selected from among:
An acrylic or cyanoacrylate adhesive which can be polymerized by UV
A monocomponent epoxy adhesive which can be pre-activated by UV
A bicomponent epoxy adhesive which can be polymerized at room temperature
An acrylic-based pressure-sensitive liquid adhesive
A polyurethane bicomponent adhesive which can be polymerized at about 80° C.

Another subject of the invention is a method for producing a smart card as described above, comprising steps consisting in forming a rolled multilayer card body, machining, in the card body, a cavity intended to receive an electronic module provided, on its lower side, with a display screen, transferring and adhesively bonding the electronic module in said cavity by orienting the lower side of the electronic module toward the lower side of the card body, characterized in that the step of forming the card body comprises a step consisting in printing, on a layer of the card body located under the electronic module, an opaque, notably white, layer provided with a transparent reservation in the zone intended to be opposite the display screen after the electronic module is integrated.

### DETAILED DESCRIPTION

The invention will be described in more detail using drawings, in which:

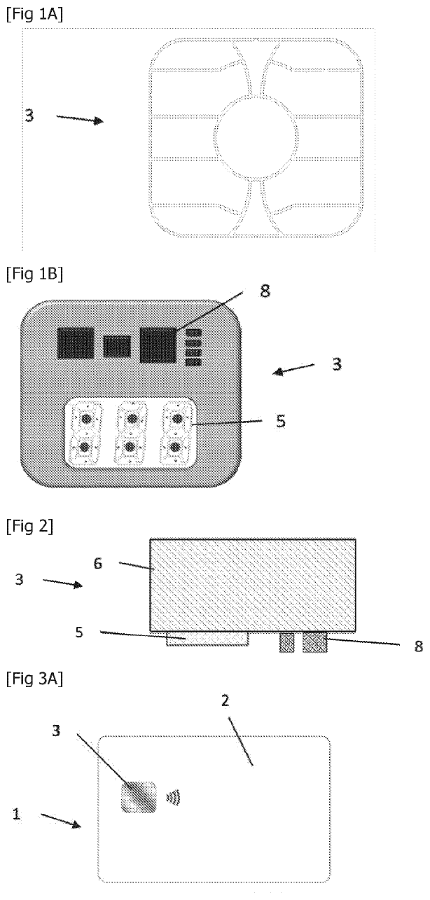

FIGS. 1A and 1B depict an electronic module for a smart card, provided with a screen, the module being depicted in a top view with the terminal block of contacts and in a bottom view with the screen, respectively.

FIG. 2 depicts a schematic view of the electronic module of FIG. 1A, in cross section.

FIGS. 3A and 3B depict a top view (front) and a bottom view (back), respectively, of a smart card integrating an electronic module of FIGS. 1A and 2 which is provided with a display screen.

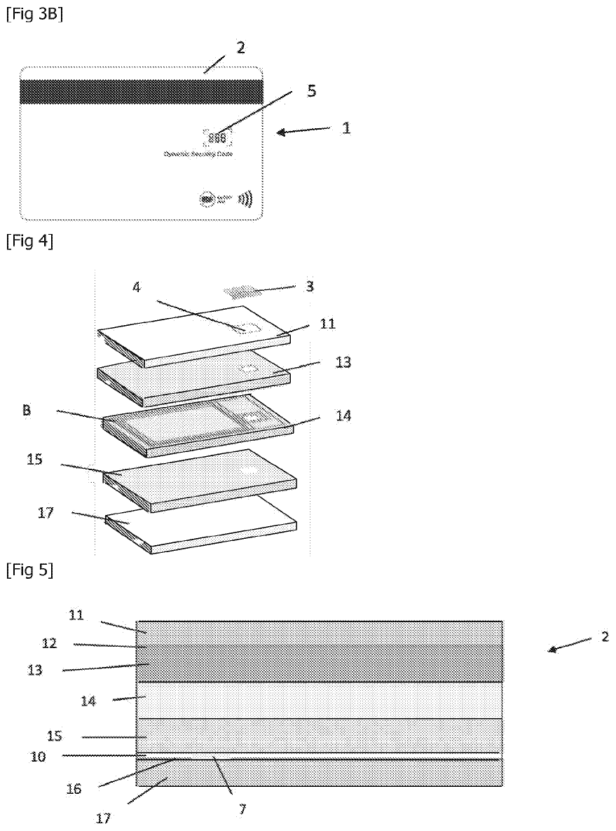

FIG. 4 depicts an exploded perspective view of a smart card according to the invention.

FIG. 5 depicts a schematic sectional view of a card body according to the invention, before the cavity intended to receive the electronic module is machined.

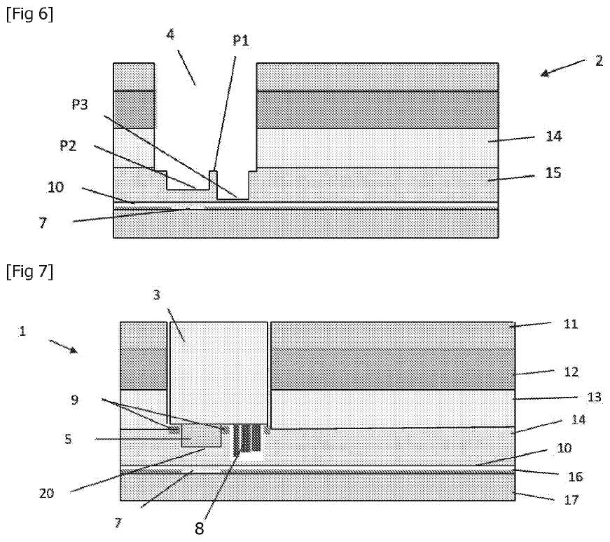

FIG. 6 depicts a schematic sectional view of a card body according to the invention, after the cavity intended to receive the electronic module is machined.

FIG. 7 depicts a schematic sectional view of a smart card according to the invention, after the electronic module is inserted into the cavity of the card body.

Reference is made to FIGS. 1 and 2, which depict an electronic module 3 for a smart card. This electronic module 3 is provided, on its upper side (FIG. 1A), with a terminal block of metal contacts which are likely to interact with the corresponding contacts of a smart card reader, as is well known. This electronic module 3 is provided, on its lower side (FIG. 1B), with a display screen 5 and with one or more discrete or integrated electronic components 8, such as, for example, a conventional security electronic component which identifies the user of the smart card, or resistors or capacitors.

As is visible in the cross section of FIG. 2, the electronic module 3 comprises a dielectric substrate 6 on which, in its upper portion, the terminal block of contacts (which is not depicted), and, in its lower portion, the display screen 5 and the electronic components 8 are mounted. The figures do not depict the possible electrical interconnections between the various components of the electronic module 3.

FIGS. 3A and 3B depict a smart card 1 according to the invention, in a top view and a bottom view, respectively. It integrates an electronic module 3 in accordance with FIGS. 1 and 2, the terminal block of the module 3 being visible on the upper side of the smart card 1 (FIG. 3A) and the display screen of the module 3 being visible on the lower side of the smart card 1 (FIG. 3B) . By virtue of this structure, all the electronic components of the smart card, except a possible antenna for radiofrequency communication with a contactless reader, are integrated into the electronic module.

FIG. 4 depicts an exploded perspective view of the smart card 1 of FIG. 3A. It comprises the electronic module 3, integrated into a card body formed by a stack of several layers of plastic material rolled together by a hot rolling method, that is to say in the region of 140° C. +/−20 degrees.

In detail, the card body comprises:
A transparent protective upper layer 11, also called an “overlay”, typically made of PVC of a thickness of the order of 40 μm to 60 μm.
A layer 13 made of white PVC of 200 μm to 250 μm in thickness, provided, on its upper side, with a graphical personalization 12 corresponding to the transmitter of the smart card.
An antenna insert 14 composed of a layer of PVC or of PET and comprising the turns of an antenna/booster B made of aluminum, the whole having a thickness of the order of 200 μm to 250 μm.
A complex 15 formed by a layer of transparent PVC comprising, on its lower side, an opaque layer 10 (FIG. 5) , notably a white opaque layer formed by screen or offset printing, and the opaque layer 10 being provided, on its lower side, with a printed graphical personalization 16. The whole of the complex 15 has a thickness of the order of 200 μm to 250 μm. In order to ensure that the display screen 5 of the module 3 is visible from the lower side of the smart card, it is essential for the opaque layer 10 of the complex 15 to comprise a reservation which has no opaque material, opposite the zone which will be occupied by the display screen 5. In other words, the opaque layer 10 will be printed on the whole surface of the complex 5, with the exception of the zone located opposite the display screen 5.
Finally, a transparent protective lower layer 17, also called an “overlay”, typically made of PVC of a thickness of the order of 40 μm to 60 μm.

FIGS. 5 to 7 depict a cross-sectional view of the smart card 1, passing through the electronic module 3, at various stages of manufacture. The same elements bear the same reference numbers in the various figures. The thicknesses of the layers depicted are modified with respect to reality, for more clarity.

FIG. 5 depicts the structure of the card body 2 composed of the rolled stack of the layers 11 to 17 which are described in relation to FIG. 4, before a cavity 4 intended to receive the electronic module 3 is machined. In particular, FIG. 5 shows the reservation zone 7 of the opaque layer 10, as described above.

FIG. 6 depicts the same structure of the card body 2, after a cavity 4 intended to receive the electronic module 3 is machined. The bottom of the cavity 4, located in the transparent layer 15, is machined to several machining depths P1, P2, P3, depending on the thickness of the substrate of the module 3, of the screen 5 and of the other electronic components 8 which are in relief on the lower side of the electronic module 3.

FIG. 7 depicts a sectional view of the smart card 1, after the electronic module 3 is integrated. As can be seen, the display screen 5 of the module 3 is at the bottom of the cavity 4, facing a portion of the transparent complex 15, and above all facing the reservation 7 formed in the opaque layer 10 thereof. Since the lower layer 17 is also transparent, it follows that the display screen 5 is indeed visible from the lower side of the smart card 1. By contrast, the other electronic components 8 are not placed opposite the reservation 7 of the opaque layer 10. They therefore remain invisible from the outside of the smart card 1.

Since the display screen 5 and the discrete components 8 typically have different thicknesses, it is useful that the bottom of the cavity 4 is machined at multiple and differentiated depths, which are adapted on a case-by-case basis depending on the thickness of the display screen 5 and the discrete components 8 corresponding to the various types of electronic modules 3 to be integrated into the card body. In this way, the fastening of the electronic module 3 in the cavity 4 using an adhesive will be optimal.

Several methods can be envisaged for optimizing the fastening of the electronic module 3 in the cavity 4 of the card body 2, and for optimizing the visibility of the display screen 5 from the lower side of the smart card. According to a first fastening mode, the electronic module 3 is fastened in the cavity 4 of the card body 2 by means of a hot-melt adhesive film 9 arranged on the lower side of the electronic module 3 on and around the display screen 5 and the other components 8 thereof which are in relief on the lower side of the electronic module.

In this case the hot-melt adhesive 9 must be transparent since it covers the whole lower surface of the module 3 including the screen 5. The hot-melt adhesive 9 can notably be a co-polyamide thermoplastic film or indeed an epoxy-based film.

According to a second fastening mode, depicted in FIG. 7, the electronic module 3 is fastened in the cavity 4 of the card body 2 by means of an opaque hot-melt adhesive film 9 which is rolled only on the periphery of the lower side of the electronic module 3 around the display screen 5 and the other components 8 thereof. The hot-melt adhesive 9 can be, in this case, a nitrile phenolic film, a co-polyamide thermoplastic film or indeed an epoxy-based film.

According to a third fastening mode, the electronic module 3 is fastened in the cavity 4 of the card body 2 by means of a transparent adhesive 20 dispensed at the bottom of the cavity 4 so as to surround and cover the display screen 5 completely. In this case there is no rolling of the adhesive. The module 3 is adhesively bonded in the cavity 4 simply using a transparent liquid adhesive 20. The latter can also make it possible to improve the readability of the screen 5 using its optical properties. In fact, since the bottom of the cavity 4 is machined, the PVC of the complex 15 can therefore have been “scratched” by the machining operation. The liquid adhesive 20 will be able to fill the bumps caused by the machining and thus improve the readability of the screen 3 through the window made of transparent PVC of the complex 15 and through the reservation 7 of its opaque layer 10.

A fourth mode for fastening the electronic module 3 consists in combining the use of a hot-melt adhesive 9 and of a liquid adhesive 20. In this case, the electronic module 3 is fastened in the cavity 4 of the card body 2 by means of the combination of a hot-melt adhesive film 9 which is rolled around the periphery of the electronic module 3, and a transparent adhesive 20 dispensed only at the bottom of the cavity 4 in the zone intended to be opposite the display screen 5. In this case, the hot-melt adhesive 9 is rolled only on the periphery of the module, and not on the screen 5. The hot-melt adhesive 9 can be a nitrile phenolic film, a co-polyamide thermoplastic film or indeed an epoxy-based film. The liquid adhesive 20 is dispensed only in the deepest zones of the cavity 4, and not in the least deep zones (P1), which are covered with the hot-melt adhesive 9. In the event that the hot-melt adhesive is enough to ensure sufficient adhesion of the module 3 in the cavity 4, the liquid adhesive 20 can be used only to improve the readability of the screen 5 using its optical properties.

The transparent liquid adhesive 20 used can be:
An acrylic or cyanoacrylate adhesive which can be polymerized by UV
A monocomponent epoxy adhesive which can be pre-activated by UV,
A bicomponent epoxy adhesive which can be polymerized at room temperature
An acrylic-based pressure-sensitive liquid adhesive
A polyurethane bicomponent adhesive which can be polymerized at around 80° C.

### Advantages of the Invention

The invention achieves the objectives set. In particular, it possesses the advantage of properly readably integrating, into a smart card, a display screen which is embedded at the back of the module while simultaneously adhesively bonding the module in the cavity and while ensuring that the display, in particular the display of a dCVV code, is indeed readable. However, the invention is applicable to other types of smart cards and applications, when the smart card possesses a display screen.

The invention makes it possible to obtain a smart screen from the back side of the smart card. The opaque white layer arranged outside the zone of the screen will make it possible to make everything which is desirably not to be seen in the card and under the electronic module, notably the antenna of the card body, the electronic components and the substrate of the module, opaque. In addition, the zone without opaque printing will make it possible to see only the screen the module. The graphical personalization of the smart card can then be printed on this opaque white layer, as on conventional smart cards which have no screen.

The integration of the electronic module provided with its screen is particularly neat, not requiring buttons or other components in the card body or on its surface.

Furthermore, the invention makes it possible not to have a module opening onto the back of the smart card, and the transparent lower layer will protect the screen from external attacks, while ensuring that it is perfectly visible.

Ultimately, the solution according to the invention makes it possible to advantageously replace dCVV cards which embed the screen and its control electronics on a PCB substrate which is relegated to the card body, away from the electronic module.

A smart card provided with such a module comprising, on its back side, a dCVV display screen can be manufactured using a method using tried and tested, reliable and economical techniques, including machining a cavity in the card body, then transferring and adhesively bonding the electronic module in the cavity. The smart card thus obtained is entirely compatible with the existing system of credit cards, and easy to deploy with both merchants and users.

1. A smart card comprising:
a card body formed by a stack of layers that are rigidly connected to one another; and
an electronic module comprising:
on an upper side of the electronic module, a terminal block of metal contacts configured to interact with the corresponding contacts of a smart card reader; and
on a lower side of the electronic module, a display screen,
wherein the electronic module is integrated into a cavity formed on the upper side of the card body,
wherein the display screen is positioned at the bottom of said the cavity in a transparent layer of the card body so as to be visible from the lower side of the smart card,
wherein the card body comprises a generally opaque layer arranged under the transparent layer of the card body and having a non-opaque reserve zone formed opposite the display screen,
wherein the bottom of the cavity has multiple machining depths, and
wherein the machining depths are adapted to the thickness of the display screen and to the thickness of other electronic components arranged on the lower side of the electronic module.

2. The smart card of claim 1, wherein the generally opaque layer is produced by white opaque printing on the transparent layer of the card body, and wherein the non-opaque reserve zone is produced by an absence of white opaque printing opposite the zone provided for the display screen.

3. The smart card of claim 2, wherein the layers of the card body comprise, in order:
a transparent upper protective layer;
a first printed layer having a graphical personalization;
an insert having an antenna;
a transparent layer in which the bottom of the cavity extends, wherein the transparent layer is coated with said the white opaque printing with the exception of the non-opaque reserve zone;
a second printed layer having a graphical personalization; and
a transparent lower protective layer.

4. The smart card of claim 1, wherein the electronic module is fastened in the cavity of the card body using a transparent hot-melt adhesive film arranged on the lower side of the electronic module on and around the display screen, and wherein the other electronic components are arranged in relief on the lower side of the electronic module.

5. The smart card of claim 1, wherein the electronic module is fastened in the cavity of the card body using an opaque hot-melt adhesive film that is rolled on the periphery of the lower side of the electronic module around the display screen and the other components thereof.

6. The smart card of claim 1, wherein the electronic module is fastened in the cavity of the card body using a transparent liquid adhesive dispensed at the bottom of the cavity so as to surround and cover the display screen.

7. The smart card of claim 1, wherein the electronic module is fastened in the cavity of the card body using:
a hot-melt adhesive film that is rolled around the periphery of the electronic module; and
a transparent liquid adhesive dispensed at the bottom of the cavity in the zone intended to be opposite the display screen.

8. The smart card of claim 7, wherein the transparent liquid adhesive comprises:
an acrylic or cyanoacrylate adhesive that can be polymerized by UV;
a monocomponent epoxy adhesive that can be pre-activated by UV;
a bicomponent epoxy adhesive that can be polymerized at room temperature;
an acrylic-based pressure-sensitive liquid adhesive; or
a polyurethane bicomponent adhesive that can be polymerized at about 80° C.

9. A method for producing the smart card of claim 1, comprising:
forming a rolled multilayer card body;
machining, in the card body, a cavity configured to receive an electronic module comprising, on its lower side, with a display screen; and
transferring and adhesively bonding the electronic module in the cavity by orienting the lower side of the electronic module toward the lower side of the smart card,
wherein forming the rolled multilayer card body comprises printing, on a layer of the card body located under the electronic module, an opaque white layer having a transparent reservation in the zone configured to be opposite the display screen after the electronic module is integrated.
